(19) United States
(12) Patent Application Publication
(10) Pub. No.: US 2025/0117668 A1
(43) Pub. Date: Apr. 10, 2025

(54) METHOD FOR MODEL TRAINING BASED ON LARGE MODEL, QUESTION ANSWERING METHOD, AND ELECTRONIC DEVICE

(71) Applicant: BEIJING BAIDU NETCOM SCIENCE TECHNOLOGY CO., LTD., Beijing (CN)

(72) Inventors: Xinran He, Beijing (CN); Xianwei Xue, Beijing (CN); Bolei He, Bejing (CN); Kunbin Chen, Beijing (CN); Jinchang Luo, Beijing (CN); Ruigao Li, Beijing (CN)

(73) Assignee: BEIJING BAIDU NETCOM SCIENCE TECHNOLOGY CO., LTD., Beijing (CN)

(21) Appl. No.: 18/987,988

(22) Filed: Dec. 19, 2024

(30) Foreign Application Priority Data
Sep. 19, 2024 (CN) 202411312081.9

(51) Int. Cl. G06N 3/096; G06N 3/0475

(52) U.S. Cl. CPC G06N 3/096; G06N 3/0475

(57) ABSTRACT

A method for model training based on a large model includes: determining a first large model as a teacher model of a language model, and performing distillation learning on the language model based on the first large model; inputting a first prompt text into the language model, and obtaining a plurality of first response texts for the first prompt text output by the language model; determining a reference response text for the first prompt text from the plurality of first response texts; and training the language model based on the reference response text for the first prompt text.

### CROSS-REFERENCE TO RELATED APPLICATION

This application claims priority to and benefits of Chinese Patent Application Serial No. 202411312081.9, filed with the State Intellectual Property Office of P. R. China on Sep. 19, 2024, the entire content of which is incorporated herein by reference.

### TECHNICAL FIELD

The disclosure relates to the technical field of artificial intelligence, in particular to the technical fields of natural language processing, deep learning, reinforcement learning and large models etc., and in particular to a method and an apparatus for model training based on a large model, a question answering method and a question answering apparatus, an electronic device, a storage medium, and a computer program product.

### BACKGROUND

Currently, the language model has advantages such as high accuracy and high processing efficiency, and is widely used in the fields of dialog, question answering, and translation. However, in the related art, training of the language model often requires to use the large model, manual labeling and other methods to label a large number of training samples.

### SUMMARY

According to a first aspect of the disclosure, a method for model training based on a large model is provided. The method includes: determining a first large model as a teacher model of a language model, and performing distillation learning on the language model based on the first large model; inputting a first prompt text into the language model and outputting, by the language model, a plurality of first response texts for the first prompt text; determining a reference response text for the first prompt text from the plurality of first response texts; and training the language model based on the reference response text for the first prompt text.

According to a second aspect of the disclosure, a question answering method is provided. The method includes: obtaining a question text; obtaining a target prompt text based on the question text; and inputting the target prompt text into a question answering model, and outputting an answer text for the question text by the question answering model, in which the question answering model is obtained through the method for model training based on a large model according to the first aspect.

According to a third aspect of the disclosure, an electronic device is provided. The electronic device includes: at least one processor; and a memory communicatively coupled to the at least one processor and storing instructions executable by the at least one processor; in which when the instructions are executed by the at least one processor, the at least one processor is caused to perform the method for model training based on a large model according to the first aspect, or the question answering method according to the second aspect.

According to a fourth aspect of the disclosure, a non-transitory computer readable storage medium is provided. The non-transitory computer readable storage medium stores computer instructions, in which the computer instructions are configured to cause a computer to perform the method for model training based on a large model according to the first aspect, or the question answering method according to the second aspect.

It should be understood that, the content described in this section is not intended to identify key or important features of embodiments of the disclosure, nor is it intended to limit the scope of the disclosure. Other features of the disclosure will be readily understood by the following specification.

### BRIEF DESCRIPTION OF THE DRAWINGS

The accompanying drawings are used for a better understanding of the disclosure and do not constitute a limitation of the disclosure.

FIG. 1 is a flow chart illustrating a method for model training based on a large model according to an embodiment of the disclosure.

FIG. 2 is a flow chart illustrating a method for model training based on a large model according to another embodiment of the disclosure.

FIG. 3 is a flow chart illustrating a method for model training based on a large model according to another embodiment of the disclosure.

FIG. 4 is a flow chart illustrating a method for model training based on a large model according to another embodiment of the disclosure.

FIG. 5 is a flow chart illustrating a method for training a reward model according to an embodiment of the disclosure.

FIG. 6 is a schematic diagram illustrating a method for model training based on a large model according to an embodiment of the disclosure.

FIG. 7 is a flow chart illustrating a question answering method according to an embodiment of the disclosure.

FIG. 8 is a block diagram illustrating an apparatus for model training based on a large model according to an embodiment of the disclosure.

FIG. 9 is a block diagram illustrating a question answering apparatus according to an embodiment of the disclosure.

FIG. 10 is a block diagram illustrating an electronic device according to an embodiment of the disclosure.

### DETAILED DESCRIPTION

Exemplary embodiments of the disclosure are described hereinafter in conjunction with the accompanying drawings, which include various details of the embodiments of the disclosure in order to aid in understanding, and should be considered exemplary only. Accordingly, those skilled in the art should recognize that various changes and modifications can be made to the embodiments described herein without departing from the scope and spirit of the disclosure. Similarly, descriptions of well-known features and structures are omitted from the following description for the sake of clarity and brevity.

Artificial intelligence (AI) is a technical science that researches and develops theories, methods, technologies and application systems for simulating, extending and expanding human intelligence. At present, AI technology has the advantages of high automation, high accuracy and low cost, and has been widely used.

Natural language processing (NLU) is a science that studies computer systems that can effectively implement natural language communication, particularly the software systems involved. The NLU is an important direction in both the fields of computer science and artificial intelligence.

Deep learning (DL) is a new research direction in the field of machine learning (ML), which is a science of learning the intrinsic laws and representation levels of sample data, making machines capable of analyzing and learning like human beings, and capable of recognizing data such as text, images, and sounds, and is widely used in speech and image recognition.

Reinforcement learning (RL), also known as re-inspired learning, evaluative learning, or augmented learning. The RL is one of the paradigms and methodologies of machine learning, configured to describe and solve the problem of maximizing the rewards or achieving a specific goal through learning strategies for agents during interaction between agents and the environment.

A large model is a machine learning model having a large parameter size and complexity, requires a large amount of computational resources and storage space for training and storage, and often requires distributed computing and special hardware acceleration techniques. The large model has stronger generalization and representation capabilities. The large model includes a large language model (LLM). The LLM is a deep learning model trained using a large amount of text data, and can generate natural language texts or understand the meaning of linguistic texts. The LLM may process a variety of natural language tasks, such as text categorization, question answering, and dialog, and is an important pathway to AI.

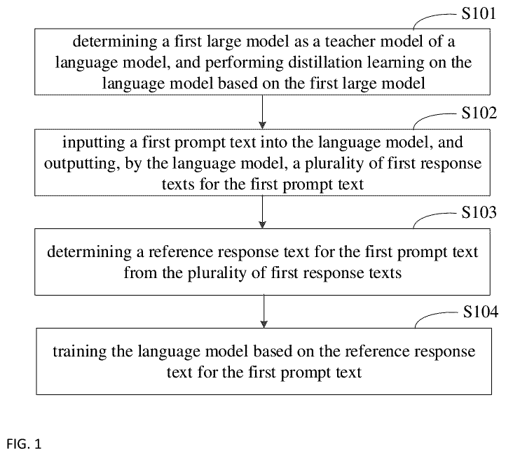

FIG. 1 is a flow chart illustrating a method for model training based on a large model according to an embodiment of the disclosure. As shown in FIG. 1, the method includes the following steps 101 to 104.

At S101, a first large model is determined as a teacher model of a language model, and distillation learning is performed on the language model based on the first large model.

It should be noted that an executing object of the method for model training based on a large model in embodiments of the disclosure may be a hardware device having a data information processing capability and/or necessary software required to drive the hardware device. Optionally, the execution object may include a workstation, a server, a computer, a user terminal, and other intelligent devices. The user terminal includes, but is not limited to, a cell phone, a computer, an intelligent voice interaction device, an intelligent home appliance, an in-vehicle terminal, and etc.

It should be noted that the language model in embodiments of the disclosure may be any language model in the related art, and is not limited herein. For example, the language model may include a dialog model, a question answering model, a translation model, a text categorization model, and etc.

It should be noted that the first large model may be implemented using any large model in the related art, and is not limited herein. For example, the first large model may be a Transformer model, a LLM, and etc. It should be noted that the Transformer model is a neural network model based on the self-attention mechanism. Performing distillation learning on the language model based on the first large model, may use any knowledge distillation method in the related art, and is not limited herein.

At S102, a first prompt text is inputted into the language model and the language model outputs a plurality of first response texts for the first prompt text.

For example, the first prompt text is generated based on an input text of the client.

For example, in the case that the language model is a dialog model, the first prompt text may carry a first dialog text, and the plurality of first response texts may include second dialog texts for the first dialog text. For example, if the first dialog text is “what day is it today”, the first prompt text “you are a chatbot, please have a dialog with the user, the user: what day is it today” may be input to the dialog model, and the dialog model may output “today is Tuesday”, “Tuesday”, “Tue.”, etc., as the first response texts.

For example, in the case that the language model is a question answering model, the first prompt text may carry a question text, and the plurality of first response texts may include answer texts for the question text. For example, if the question text is “what is a large model”, a first prompt text “you are a question answering bot, please answer the question of the user, the question of the user is: what is a large model” may be input to the question answering model, and the question answering model outputs “the large model is a machine learning model having a large parameter size and complexity”, “the large model has stronger generalization and representation capabilities”, “the large model includes a LLM”, etc., as the first response texts.

For example, in the case that the language model is a translation model, the first prompt text may carry a text to be translated. The plurality of first response texts may include translated texts of the text to be translated.

For example, in the case that the language model is a text categorization model, the first prompt text may carry a text to be categorized. The plurality of first response texts may include categories of the text to be categorized, and/or, a probability of the text to be categorized under each category.

It should be noted that the number of the first response texts for one first prompt text is not limited. For example, the number of the first response texts may be five.

At S103, a reference response text for the first prompt text is determined from the plurality of first response texts.

It should be noted that the plurality of first response texts include the reference response text. The number of reference response texts for one first prompt text is at least one. The reference response text may be different for different first prompt texts.

It may be understood that the first response text generated by the language model may not necessarily to be correct, and may include content errors, grammatical errors, spelling errors, semantic errors, poor readability, and other problems. At a training scenario in which multiple rounds of iterations are performed on the language model, the correctness of the plurality of first response texts generated by the language model increases, so that the determined reference response text for the first prompted text is closer to a manual labeling result, and the accuracy is increased.

In an implementation, determining the reference response text for the first prompt text from the plurality of first response texts includes obtaining correct probabilities of the plurality of first response texts, and determining the reference response text for the first prompt text from the plurality of first response texts based on the correct probabilities. Thus, the reference response text for the first prompt text may be determined from the plurality of first response texts by considering the correct probability, which helps to obtain a reference response text for the first prompt text with a higher correct probability, and improves the accuracy of the reference response text for the first prompt text.

In some embodiments, obtaining the correct probabilities of the plurality of first response texts includes inputting each first response text to a correct probability prediction model, and outputting a correct probability of each first response text by the correct probability prediction model. It should be noted that the correct probability prediction model is not limited. For example, the correct probability prediction model may include a DL model, a mechanistic model, and etc.

In some embodiments, determining the reference response text for the first prompt text from the plurality of first response texts based on the correct probabilities includes determining a first response text corresponding to a maximum correct probability as the reference response text for the first prompt text.

In some embodiments, determining the reference response text for the first prompt text from the plurality of first response texts based on the correct probabilities includes: determining a first response text corresponding to a correct probability that is greater than a set threshold as the reference response text for the first prompt text, and/or, sorting the plurality of first response texts in a descending order based on the correct probabilities, and determining the top N first response texts as the reference response texts for the first prompt text, in which N is a positive integer.

In an implementation, determining the reference response text for the first prompt text from the plurality of first response texts includes: obtaining a problem detection result of each first response text by performing a problem detection on each first response text, and determining the reference response text for the first prompt text from the plurality of first response texts based on the problem detection result. Thus, the reference response text for the first prompt text may be determined from the plurality of first response texts by considering the problem detection result, which helps to obtain the reference response text for the first prompt text that does not have any problem, and improves the accuracy of the reference response text for the first prompt text.

It should be noted that performing the problem detection on the first response text may be realized using any of the text problem detection methods in the related art, and is not limited herein.

In some embodiments, obtaining the problem detection result of each first response text by performing the problem detection on each first response text includes: inputting each first response text to a problem detection model, and outputting the problem detection result of each first response text by the problem detection model.

In some embodiments, obtaining the problem detection result of each first response text by performing the problem detection on each first response text includes: identifying whether each first response text conforms to a rule in a set rule base, and in response to a first response text not conforming to at least one of the rules in the set rule base, generating a problem detection result for indicating that a problem exists in the first response text.

In some embodiments, determining the reference response text for the first prompt text from the plurality of first response texts based on the problem detection result includes: determining a first response text for which the problem detection result indicates that no problem exists as the reference response text for the first prompt text.

At S104, the language model is trained based on the reference response text for the first prompt text.

It should be noted that training the language model based on the reference response text for the first prompt text refers to training the language model using the reference response text for the first prompt text as a label. The training of the language model based on the reference response text for the first prompt text may be realized by any of the model training methods in the related art, which is not limited herein.

In an implementation, training the language model based on the reference response text for the first prompt text includes: inputting the first prompt text to the language model, outputting a fourth response text for the first prompt text by the language model, and training the language model based on the fourth response text and the reference response text for the first prompt text. Thus, the first prompt text may be re-inputted to the language model, and the language model may further generate the fourth response text for the first prompt text, and the language model may be trained based on the fourth response text and the reference response text for the first prompt text.

In some embodiments, training the language model based on the fourth response text and the reference response text for the first prompt text includes: obtaining a loss function of the language model based on the fourth response text and the reference response text for the first prompt text, and training the language model based on the loss function of the language model. It should be noted that the loss function is not limited. For example, the loss function may include a cross entropy (CE), a mean-square error (MSE), a kullback-leibler (KL) scatter, a contrastive loss function, and etc.

For example, in the case that the language model is a dialog model, the first prompt text 1 “you are a chatbot, please have a dialog with the user, the user: what day is it today” may be input to the dialog model, and the dialog model may output “today is Tuesday”, “Tuesday,” “Tue.”, etc., as the first response texts. The reference response text for the first prompt text 1 is determined from the plurality of first response texts. For example, the reference response text for the first prompt text 1 is “today is Tuesday”. The dialog model is trained based on the reference response text for the first prompt text 1.

For example, in the case that the language model is a dialog model, the first prompt text 2 “you are a chatbot, please have a dialog with the user, the user: how is the air quality today” may be input to the dialog model, and the dialog model may output “the air quality today is excellent”, “excellent”, “the air quality today is excellent, the air is very good, you can do normal activities, go and get some fresh air” etc., as the first response texts. The reference response text for the first prompt text 2 is determined from the plurality of first response texts. For example, the reference response text for the first prompt text 2 is “the air quality today is excellent, the air is very good, you can do normal activities, go and get some fresh air”. The dialog model is trained based on the reference response text for the first prompt text 2.

For example, in the case that the language model is a question answering model, the first prompt text “you are a question answering bot, please answer the question of the user, the question of the user is: what is a large model” may be input to the question answering model, and the question answering model outputs “the large model is a machine learning model having a large parameter size and complexity”, “the large model has stronger generalization and representation capabilities”, “the large model includes a LLM”, etc., as the first response texts. The reference response text for the first prompt text 3 is determined from the plurality of first response texts described above. For example, the reference response text for the first prompt text 3 is “the large model is a machine learning model having a large parameter size and complexity”. The dialog model is trained based on the reference response text for the first prompt text 3.

It should be noted that the training contents of other types of language models may refer to the training contents of the dialog model and the question answering model, which are not repeated herein.

With the method for model training based on a large model provided in the disclosure, the first large model is determined as the teacher model of the language model, and the distillation learning is performed on the language model based on the first large model, the first prompt text is input into the language model, and the language model outputs a plurality of first response texts for the first prompt text, the reference response text for the first prompt text is determined from the plurality of first response texts, and the language model is trained based on the reference response text for the first prompt text. Thus, the first large model may be used as the teacher model of the language model to perform the distillation learning on the language model, that is, the knowledge of the first large model may be migrated to the language model. The language model has the advantages of small size, high accuracy and fast inference speed. In addition, the reference response text for the first prompt text may be determined from the plurality of first response texts to train the language model. Thus, the reference response text of the language model can be obtained automatically and the self-evolution of the language model may be realized, and the labeling does not need to rely on the large model and manual labeling, which saves the labeling time of the training samples of the language model, improves the training efficiency of the language model, and is especially suitable for the training scenario in which multiple rounds of iterations have been performed on the language model. In addition, the first prompt text and the reference response text for the first prompt text may be obtained in the real service scenario of the language model, which makes the training samples of the language model closer to the real service scenario, improves the authenticity and diversity of the training samples of the language model, and improves the generalization and applicability of the language model in the real service scenario.

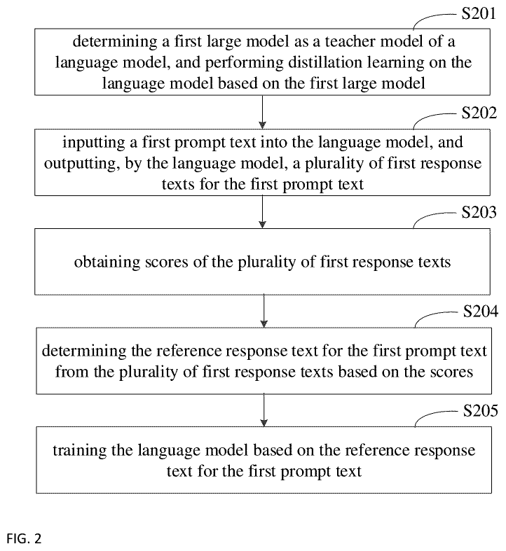

In the above embodiments, determining the reference response text for the first prompt text from the plurality of first response texts in step S103, may be further understood in combination with FIG. 2. FIG. 2 is a flow chart illustrating a method for model training based on a large model according to another embodiment of the disclosure. As shown in FIG. 2, the method includes the following steps S201 to S205.

At S201, a first large model is determined as a teacher model of a language model, and distillation learning is performed on the language model based on the first large model.

At S202, a first prompt text is inputted into the language model, and the language model outputs a plurality of first response texts for the first prompt text.

The relevant contents of step S201 to step S202 may be referred to in the above embodiments, which are not repeated herein.

At S203, scores of the plurality of first response texts are obtained.

It may be understood that different first response texts may have different scores.

In an implementation, obtaining the scores of the plurality of first response texts includes: inputting the plurality of first response texts into a text scoring model, and outputting the scores of the plurality of first response texts by the text scoring model.

In an implementation, obtaining the scores of the plurality of first response texts includes: inputting the first prompt text and each first response text into a reward model, and outputting a reward for each first response text by the reward model; and using the reward for each first response text as the score of a corresponding first response text. Thus, the scores of the plurality of first response texts may be obtained by obtaining the reward for each first response text by the reward model. That is, the scores of the plurality of first response texts may be obtained by constructing the reward model based on the RL technology, which improves the accuracy of the scores of the plurality of first response texts.

It should be noted that the reward model is not limited. For example, the reward model may include a DL model, a mechanistic model, and etc.

In an implementation, obtaining the scores of the plurality of first response texts includes: inputting the first prompt text and each the first response text into a second large model, and outputting scores of the plurality of first response texts by the second large model. Thus, the scores of the plurality of first response texts may be obtained using the second large model. That is, the scores of the plurality of first response texts may be obtained based on the DL technology, which improves the accuracy of the scores of the plurality of first response texts. The second large model has a better generalization, which is applicable to the scoring scenarios of the first response texts of multiple categories.

It should be noted that the relevant contents of the second large model may refer to the relevant contents of the first large model, and are not repeated herein. For example, the second large model is consistent with the first large model.

In some embodiments, the method further includes: obtaining, based on the first prompt text, a second response text for the first prompt text via the second large model; and obtaining, based on the plurality of first response texts and the second response text, the scores of the plurality of first response texts via the second large model. Thus, the second response text for the first prompt text may be generated via the second large model, and the scores of the plurality of first response texts may be obtained by considering both the first response texts and the second response text.

For example, obtaining, based on the plurality of first response texts and the second response text, the scores of the plurality of first response texts via the second large model includes: obtaining a similarity between each first response text and the second response text as a score of each first response text via the second large model.

For example, obtaining, based on the plurality of first response texts and the second response text, the scores of the plurality of first response texts via the second large model includes: obtaining a first text feature by performing feature extraction on each first response text via the second large model, obtaining a second text feature by performing feature extraction on the second response text, and obtaining a similarity between the first text feature and the second text feature via the second large model as the score of the corresponding first response text.

At S204, the reference response text for the first prompt text is determined from the plurality of first response texts based on the scores.

In an implementation, determining the reference response text for the first prompt text from the plurality of first response texts based on the scores includes: determining a first response text with a score greater than a set threshold as the reference response text for the first prompt text, and/or, sorting the plurality of first response texts in a descending order based on the scores, and determining top N first response texts as the reference response texts for the first prompt text, in which N is a positive integer.

At S205, the language model is trained based on the reference response text for the first prompt text.

The relevant contents of step S205 may be referred to in the above embodiments, and are not repeated herein.

With the method for model training based on a large model provided in the disclosure, scores of the plurality of first response texts are obtained, and the reference response text for the first prompt text is determined from the plurality of first response texts based on the scores. Thus, the reference response text for the first prompt text may be determined from the plurality of first response texts based on the scores, which helps to obtain the reference response text for the first prompt text with a higher score, and improves the accuracy of the reference response text for the first prompt text.

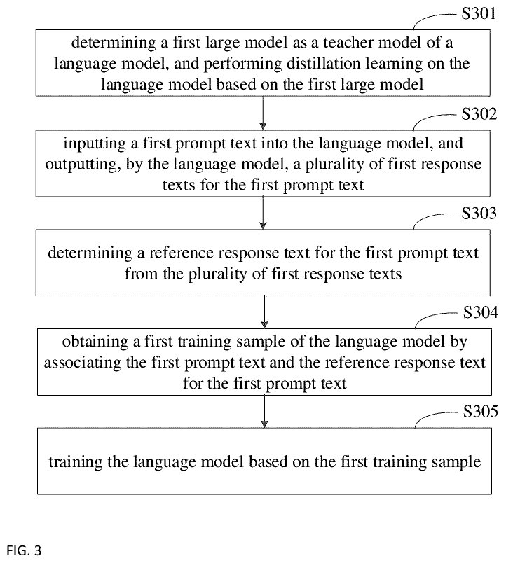

In the above embodiments, training the language model based on the reference response text for the first prompt text in step S104, may be further understood in combination with FIG. 3. FIG. 3 is a flow chart illustrating a method for model training based on a large model according to another embodiment of the disclosure. As shown in FIG. 3, the method includes the following steps S301 to S305.

At S301, a first large model is determined as a teacher model of a language model, and distillation learning is performed on the language model based on the first large model.

At S302, a first prompt text is inputted into the language model, and the language model outputs a plurality of first response texts for the first prompt text.

At S303, a reference response text for the first prompt text is determined from the plurality of first response texts.

The relevant contents of step S301 to step S303 may be referred to in the above embodiments, and are not repeated herein.

At S304, a first training sample of the language model is obtained by associating the first prompt text and the reference response text for the first prompt text.

It should be noted that associating the first prompt text and the reference response text for the first prompt text may be realized using any of the data associating methods in the related art, and is not limited herein. For example, a mapping relationship, a correspondence relationship, etc., between the first prompt text and the reference response text for the first prompt text may be established. For example, the first prompt text and the reference response text for the first prompt text may be associated using the reference response text for the first prompt text as a label, to obtain the first training sample of the language model.

For example, in the case that the first prompt text is the first prompt text 1 described above, a first training sample A of the dialog model may be obtained by associating the first prompt text 1 “you are a chatbot, please have a dialog with the user, the user: what day of is it today” and the reference response text “today is Tuesday” of the first prompt text 1.

For example, in the case that the first prompt text is the first prompt text 2 described above, a first training sample B of the dialog model may be obtained by associating the first prompt text 2 “you are a chatbot, please have a dialog with the user, the user: how is the air quality today” and the reference response text “the air quality today is excellent, the air is very good, you can do normal activities, go and get some fresh air” of the first prompt text 2.

For example, in the case that the first prompt text is the first prompt text 3 described above, a first training sample C of the question answering model may be obtained by associating the first prompt text 3 “you are a question answering bot, please answer the question of the user, the question of the user is: what is a large model”, and the reference response text “the large model is a machine learning model having a large parameter size and complexity” of the first prompt text 3.

At S305, the language model is trained based on the first training sample.

It should be noted that the training of the language model based on the first training sample may be realized using any of the model training methods in the related art, and is not limited herein. For example, the relevant contents of step S305 may refer to the relevant contents of step S104, and are not repeated herein.

For example, the dialog model may be trained based on the first training samples A or B of the dialog model.

For example, the question answering model may be trained based on the first training sample C of the question answering model.

With the method for model training based on a large model provided in the disclosure, the first training sample of the language model is obtained by associating the first prompt text and the reference response text for the first prompt text, and the language model is trained based on the first training sample. As a result, the first training sample may be obtained by associating the first prompt text and the reference response text for the first prompt text to train the language model. During the training process, the language model may learn a relationship between the first prompt text and the reference response text for the first prompt text, so that the trained language model may generate a response text for a prompt text based on the prompt text.

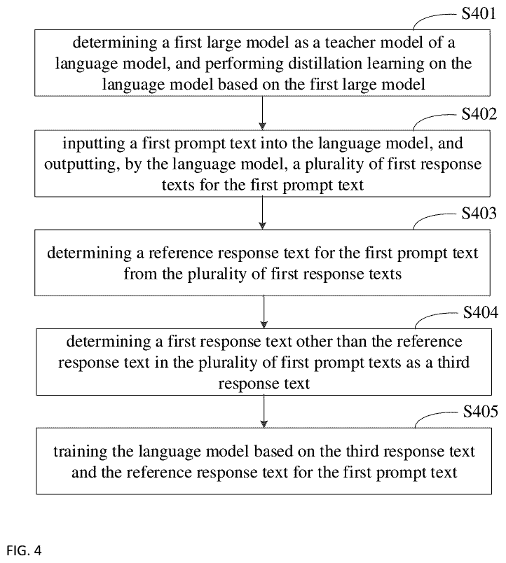

In the above embodiments, training the language model based on the reference response text for the first prompt text in step S104, may be further understood in combination with FIG. 4. FIG. 4 is a flow chart illustrating a method for model training based on a large model according to another embodiment of the disclosure. As shown in FIG. 4, the method includes the following steps S401 to S405.

At S401, a first large model is determined as a teacher model of a language model, and distillation learning is performed on the language model based on the first large model.

At S402, a first prompt text is inputted into the language model, and the language model outputs a plurality of first response texts for the first prompt text.

At S403, the reference response text for the first prompt text is determined from the plurality of first response texts.

The relevant contents of step S401 to step S403 may be referred to in the above embodiments, and are not repeated herein.

At S404, a first response text other than the reference response text in the plurality of first prompt texts are determined as a third response text.

It should be noted that the plurality of first response texts include the third response text. The number of third response texts for one first prompt text is at least one. For example, the number of third response texts for the first prompt text is M−1, in which M is a number of the plurality of first response texts for the first prompt text, and M is a positive integer greater than 1.

For example, in the case that the first prompt text is the first prompt text 1 described above. The first prompt text 1 is “you are a chatbot, please have a dialog with the user, the user: what day is it today”. The plurality of first response texts for the first prompt text 1 include “today is Tuesday”, “Tuesday”, “Tue.”, etc. The reference response text for the first prompt text 1 is “today is Tuesday”. The third response texts for the first prompt text 1 may include “Tuesday” and “Tue.”.

For example, in the case that the first prompt text is the first prompt text 2 described above. The first prompt text 2 is “you are a chatbot, please have a dialog with the user, the user: how is the air quality today”. The plurality of first response texts for the first prompt text 2 include “the air quality today is excellent”, “excellent”, “the air quality today is excellent, the air is very good, you can do normal activities, go and get some fresh air” etc. The reference response text for the first prompt text 2 is “the air quality today is excellent, the air is very good, you can do normal activities, go and get some fresh air”. The third response texts for the first prompt text 2 may include “the air quality today is excellent” and “excellent”.

For example, in the case that the first prompt text is the first prompt text 3 described above. The first prompt text 3 is “you are a question answering bot, please answer the question of the user, the question of the user is: what is a large model”. The plurality of first response texts for the first prompt text 3 include “the large model is a machine learning model having a large parameter size and complexity”, “the large model has stronger generalization and representation capabilities”, “the large model includes a LLM”, etc. The reference response text for the first prompt text 3 is “the large model is a machine learning model having a large parameter size and complexity”. The third response texts for the first prompt text 3 may include “the large model has stronger generalization and representation capabilities” and “the large model includes a LLM”.

At S405, the language model is trained based on the third response text and the reference response text for the first prompt text.

It should be noted that the training of the language model based on the third response text and the reference response text for the first prompt text may be realized using any of the model training methods in the related art, and is not limited herein. For example, the relevant contents of step S405 may refer to the relevant contents of step S104, and are not repeated herein.

In an implementation, training the language model based on the third response text and the reference response text for the first prompt text includes: obtaining a loss function of the language model based on the third response text and the reference response text for the first prompt text, and training the language model based on the loss function of the language model.

For example, in the case that the first prompt text is the first prompt text 1 described above, the dialog model may be trained based on the third response texts “Tuesday” and “Tuesday of the week” for the first prompt text 1, and the reference response text “today is Tuesday” for the first prompt text 1.

For example, in the case that the first prompt text is the first prompt text 2 described above, the dialog model may be trained based on the third response texts “the air quality today is excellent” and “excellent” for the first prompt text 2, and the reference response text “the air quality today is excellent, the air is very good, you can do normal activities, go and get some fresh air” for the first prompt text 2.

For example, in the case that the first prompt text is the first prompt text 3 described above, the dialogue model may be trained based on the third response texts “the large model has stronger generalization and representation capabilities” and “the large model includes a LLM” for the first prompt text 3, and the reference response text “the large model is a machine learning model having a large parameter size and complexity” for the first prompt text 3.

With the method for model training based on a large model provided in the disclosure, the first response text other than the reference response text in the plurality of first prompt texts is determined as a third response text; and the language model is trained based on the third response text and the reference response text for the first prompt text. Thus, the language model may be trained directly based on the one or more first response texts other than the reference response text in the plurality of first prompt texts, and the reference response text of the first prompt text. The response texts other than the plurality of first response texts, are not required to be obtained to train the language model, which saves the obtaining time of the training samples of the language model, and improves the training efficiency of the language model.

Based on any of the above embodiments, performing distillation learning on the language model based on the first large model includes: inputting a second prompt text into the first large model, and outputting a reference response text for the second prompt text by the first large model; obtaining a second training sample of the language model by associating the second prompt text and the reference response text for the second prompt text; and training the language model based on the second training sample. Thus, the reference response text for the second prompt text may be obtained using the first large model, and the second training sample may be obtained by associating the second prompt text and the reference response text for the second prompt text to train the language model. During the training process, the language model may learn a relationship between the second prompt text and the reference response text for the second prompt text, so that the trained language model may generate a response text for the prompt text based on the prompt text.

It should be noted that the relevant contents of the second prompt text may refer to the relevant contents of the first prompt text; the relevant contents of the reference response text for the second prompt text may refer to the relevant contents of the reference response text for the first prompt text; the relevant contents of obtaining a second training sample of the language model by associating the second prompt text and the reference response text for the second prompt text may refer to the relevant contents of step S304; the relevant contents of training the language model based on the second training sample may refer to the relevant contents of step S305; and are not repeated herein.

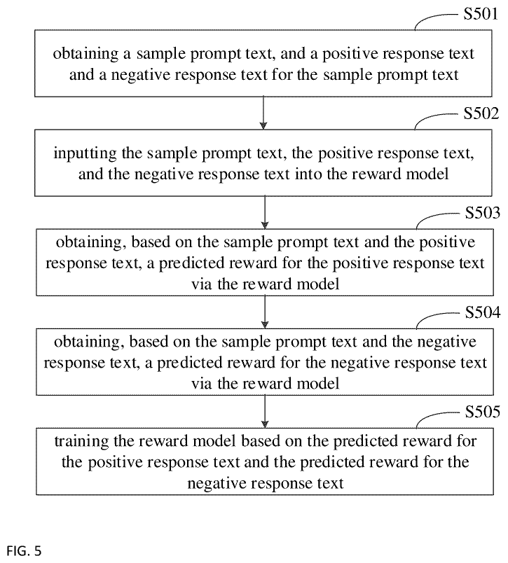

In the above embodiment, the training of the reward model may be further understood in combination with FIG. 5. FIG. 5 is a flow chart illustrating a method for training a reward model according to an embodiment of the disclosure. As shown in FIG. 5, the method includes the following steps S501 to S505.

At S501, a sample prompt text, and a positive response text and a negative response text for the sample prompt text are obtained.

It should be noted that the accuracy of the positive response text is higher than the accuracy of the negative response text. That is, the positive response text refers to the sample response text for the sample prompt text with higher accuracy, and the negative response text refers to the sample response text for the sample prompt text with lower accuracy. For example, the positive response text refers to a correct sample response text for the sample prompt text, and the negative response text refers to an incorrect sample response text for the sample prompt text.

In an implementation, the method further includes obtaining a reference response text for the sample prompt text sent by the client of a labeling user as the positive response text. Thus, the positive response text may be obtained based on manual labeling.

In an implementation, the method further includes: obtaining a plurality of sample response texts for the sample prompt text; and labeling, based on feedback data from a user group for the plurality of sample response texts, each of the plurality of sample response texts as the positive response text or the negative response text. Thus, each of the plurality of sample response texts may be labeled as the positive response text or the negative response text based on the feedback data from the user group for the plurality of sample response texts. The automatic labeling of the positive response text and the negative response text may be realized, without relying on the manual labeling. This saves the labeling time of the training samples of the reward model and improves the training efficiency of the reward model.

It may be understood that the feedback data from the user group for the plurality of sample response texts may include data fed back for the plurality of sample response texts by the user group when the plurality of sample response texts are displayed on a client corresponding to the user group. For example, the feedback data may include the number of likes, the number of views, the length of views, the number of complaints, etc. of the user group for the plurality of sample response texts.

In some embodiments, labeling, based on the feedback data from the user group for the plurality of sample response texts, each of the plurality of sample response texts as the positive response text or the negative response text includes: obtaining scores of the plurality of sample response texts based on the feedback data from the user group for the plurality of sample response texts; labeling a sample response text corresponding to a score that is greater than a set threshold as the positive response text; and labeling a sample response text corresponding to a score that is less than or equal to the set threshold as the negative response text.

It should be noted that the relevant contents of the sample prompt text may refer to the relevant contents of the first prompt text, and the relevant contents of the sample response text may refer to the relevant contents of the first response text, and are not repeated herein.

At S502, the sample prompt text, the positive response text, and the negative response text are input into the reward model.

At S503, a predicted reward for the positive response text is obtained via the reward model based on the sample prompt text and the positive response text.

At S504, a predicted reward for the negative response text is obtained via the reward model based on the sample prompt text and the negative response text.

It may be understood that the predicted reward for the positive response text and the predicted reward for the negative response text may be different.

At S505, the reward model is trained based on the predicted reward for the positive response text and the predicted reward for the negative response text.

It should be noted that the training of the reward model based on the predicted reward for the positive response text and the predicted reward for the negative response text may be realized using any of the model training methods in the related art, and is not limited herein.

It may be understood that the accuracy of the positive response text is higher than the accuracy of the negative response text, and theoretically, the predicted reward for the positive response text should be greater than the predicted reward for the negative response text. However, the predicted reward generated by the reward model during the training process is not necessarily correct, and the predicted reward for the positive response text may be less than or equal to the predicted reward for the negative response text.

In an implementation, training the reward model based on the predicted reward for the positive response text and the predicted reward for the negative response text includes: obtaining a loss function of the reward model based on a difference parameter between the predicted reward for the positive response text and the predicted reward for the negative response text; and training the reward model based on the loss function of the reward model. Thus, the loss function of the reward model may be obtained based on the difference parameter between the predicted reward for the positive response text and the predicted reward for the negative response text, to train the reward model without the need of labeling the specific value of the reward. This saves the labeling time of the training samples of the reward model and improves the training efficiency of the reward model.

It should be noted that the loss function of the reward model is not limited. For example, the loss function may include the contrastive loss function, and etc.

In an implementation, training the reward model based on the predicted reward for the positive response text and the predicted reward for the negative response text includes: obtaining a first loss function of the reward model based on the predicted reward for the positive response text and the reference reward for the positive response text; obtaining a second loss function of the reward model based on the predicted reward for the negative response text and the reference reward for the negative response text, and training the reward model based on the first loss function and the second loss function. For example, a total loss function of the reward model is obtained by summing the first loss function and the second loss function, and the reward model is trained based on the total loss function of the reward model.

With the method for training the reward model provided by the disclosure, the sample prompt text, and the positive response text and the negative response text for the sample prompt text are obtained, the sample prompt text, the positive response text, and the negative response text are input into the reward model, the predicted reward for the positive response text is obtained via the reward model based on the sample prompt text and the positive response text, the predicted reward for the negative response text is obtained via the reward model based on the sample prompt text and the negative response text, and the reward model is trained based on the predicted reward for the positive response text and the predicted reward for the negative response text. Thus, the sample prompt text, the positive response text, and the negative response text may be input into the reward model, the predicted reward for the positive response text and the predicted reward for the negative response text are obtained via the reward model, and the reward model is trained based on the predicted reward for the positive response text and the predicted reward for the negative response text. The training accuracy of the reward model is improved. During the training process, the reward model may learn a relationship between the reward for the positive response text and the reward for the negative response text, so that the trained reward model may obtain the reward for the response text based on the prompt text and the response text.

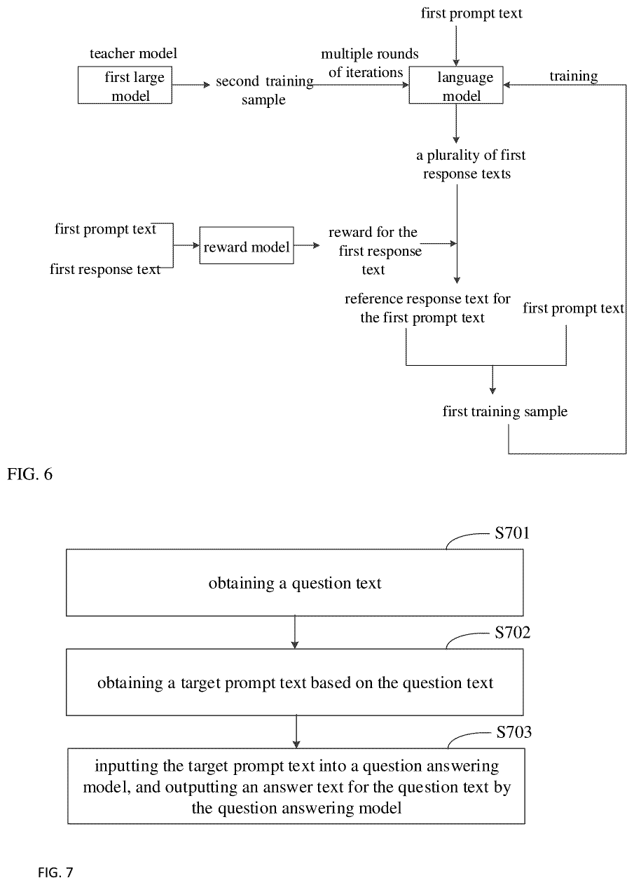

On the basis of any of the above embodiments, as shown in FIG. 6, the first large model is determined as the teacher model of the language model, i.e., the language model is a student model. A second training sample of the language model is obtained via the first large model, and multiple rounds of iterations of the language model are performed based on the second training sample.

After multiple rounds of iterations of the language model are performed based on the second training sample, the first prompt text is inputted into the language model and the language model outputs the plurality of first response texts for the first prompt text, the first prompt text and each first response text are input into a reward model, and the reward model outputs a reward for each first response text, to determine the reference response text for the first prompt text from the plurality of first response texts. The first training sample of the language model is obtained by associating the first prompt text and the reference response text for the first prompt text; and the language model is trained based on the first training sample.

FIG. 7 is a flow chart illustrating a question answering method according to an embodiment of the disclosure. As shown in FIG. 7, the method includes the following steps S701 to S703.

At S701, a question text is obtained.

It should be noted that an executing object of the question answering method in embodiments of the disclosure may be a hardware device having a data information processing capability and/or a necessary software required to drive the hardware device. Optionally, the execution object may include a workstation, a server, a computer, a user terminal, and other intelligent devices. The user terminal includes, but is not limited to, a cell phone, a computer, an intelligent voice interaction device, an intelligent home appliance, a vehicle terminal, and etc.

It should be noted that the question text is not limited. For example, the question text may include at least one language such as Chinese, English, and etc. The obtaining of the question text may be realized using the question text obtaining modes in any of the question answering methods in the related art, and is not limited herein.

For example, the question text sent by a client may be received.

For example, a question answering request sent by the client may be received, and the question text may be extracted from the question answering request.

At S702, a target prompt text is obtained based on the question text.

It should be noted that the obtaining of the target prompt text based on the question text may be realized using any of the methods for obtaining the prompt text of the language model in the related art, and is not limited herein.

For example, a template of the prompt text may be obtained, and the target prompt text is obtained by replacing the text to be replaced in the template of the prompt text with the question text.

For example, the question text may be used as the target prompt text.

At S703, the target prompt text is input into a question answering model, and the question answering model outputs an answer text for the question text.

It should be noted that in the embodiments of the disclosure, the question answering model is obtained through the method for model training based on a large model according to the disclosure.

For example, in the case that the question text is “what is a large model”, the target prompt text “you are a question answering bot, please answer the question of the user, the question of the user is: what is a large model” is obtained based on the question text. The target prompt text is input into the question answering model, and the question answering model outputs the answer text of the question text. For example, the answer text of the above question text is “the large model is a machine learning model having a large parameter size and complexity”.

With the question answering method provided in the disclosure, the question text is obtained, the target prompt text is obtained based on the question text, and the target prompt text is input into the question answering model, and the answer text for the question text is output by the question answering model, in which the question answering model is obtained through the method for model training based on a large model according to the disclosure. The question answering model has the advantages of small size, high accuracy and fast inference speed, which improves the efficiency of generating the answer text, i.e., improves the question answering efficiency, and thus improves the user experience in the question answering scenario. In addition, the question answering model has good generalization and applicability, which improves the accuracy of the answer text and is applicable to a plurality of question answering scenarios.

In the technical solution of the disclosure, the acquisition, storage, application, processing, transmission, provision and disclosure of the personal information of the users are all carried out under the premise of obtaining the consent of the users and are in compliance with relevant laws and regulations, and do not violate public order and morals.

According to an embodiment of the disclosure, an apparatus for model training based on a large model is also provided for implementing the method for model training based on a large model.

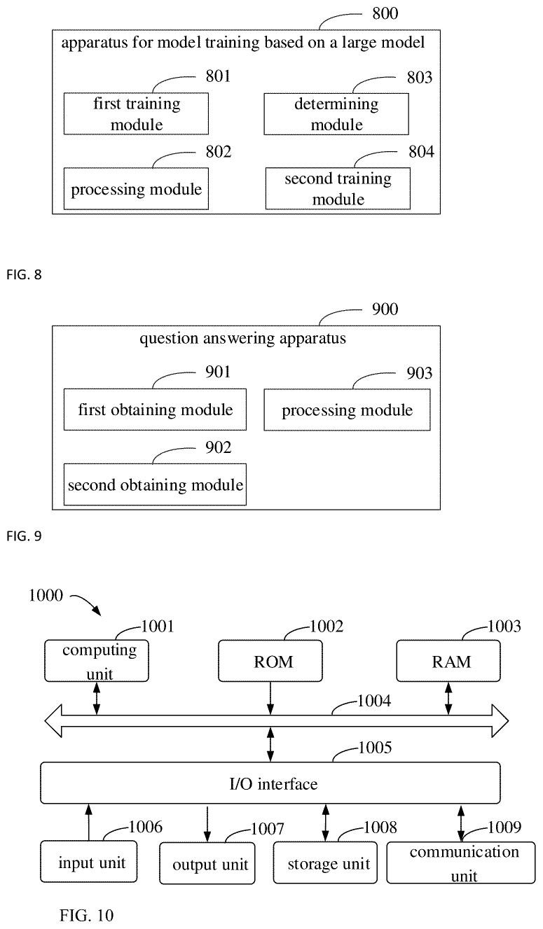

FIG. 8 is a block diagram illustrating an apparatus for model training based on a large model according to an embodiment of the disclosure.

As shown in FIG. 8, the apparatus 800 for model training based on a large model includes: a first training module 801, a processing module 802, a determining module 803, and a second training module 804.

The first training module 801 is configured to determine a first large model as a teacher model of a language model, and perform distillation learning on the language model based on the first large model;

The processing module 802 is configured to input a first prompt text into the language model, and output, by the language model, a plurality of first response texts for the first prompt text;

The determining module 803 is configured to determine a reference response text for the first prompt text from the plurality of first response texts; and

The second training module 804 is configured to train the language model based on the reference response text for the first prompt text.

In an embodiment of the disclosure, the determining module 803 is further configured to: obtain scores of the plurality of first response texts; and determine the reference response text for the first prompt text from the plurality of first response texts based on the scores.

In an embodiment of the disclosure, the determining module 803 is further configured to: input the first prompt text and each first response text into a reward model, and output a reward for each first response text by the reward model; and use the reward for each first response text as the score of a corresponding first response text.

In an embodiment of the disclosure, the determining module 803 is further configured to: input the first prompt text and each the first response text into a second large model, and output scores of the plurality of first response texts by the second large model.

In an embodiment of the disclosure, the determining module 803 is further configured to: obtain, based on the first prompt text, a second response text for the first prompt text via the second large model; and obtain, based on the plurality of first response texts and the second response text, the scores of the plurality of first response texts via the second large model.

In an embodiment of the disclosure, the second training module 804 is further configured to: obtain a first training sample of the language model by associating the first prompt text and the reference response text for the first prompt text; and train the language model based on the first training sample.

In an embodiment of the disclosure, the second training module 804 is further configured to determine a first response text other than the reference response text in the plurality of first prompt texts as a third response text; and train the language model based on the third response text and the reference response text for the first prompt text.

In an embodiment of the disclosure, the first training module 801 is further configured to: input a second prompt text into the first large model, and output a reference response text for the second prompt text by the first large model; obtain a second training sample of the language model by associating the second prompt text and the reference response text for the second prompt text; and train the language model based on the second training sample.

In an embodiment of the disclosure, the apparatus 800 further includes a third training module, configured to: obtain a sample prompt text, and a positive response text and a negative response text for the sample prompt text; input the sample prompt text, the positive response text, and the negative response text into the reward model; obtain, based on the sample prompt text and the positive response text, a predicted reward for the positive response text via the reward model; obtain, based on the sample prompt text and the negative response text, a predicted reward for the negative response text via the reward model; and train the reward model based on the predicted reward for the positive response text and the predicted reward for the negative response text.

In an embodiment of the disclosure, the third training module is further configured to: obtain a loss function of the reward model based on a difference parameter between the predicted reward for the positive response text and the predicted reward for the negative response text; and train the reward model based on the loss function of the reward model.

In an embodiment of the disclosure, the third training module is further configured to: obtain a plurality of sample response texts for the sample prompt text; and label, based on feedback data from a user group for the plurality of sample response texts, each of the plurality of sample response texts as the positive response text or the negative response text.

With the apparatus for model training based on a large model provided in the disclosure, the first large model is determined as the teacher model of the language model, and distillation learning is performed on the language model based on the first large model; the first prompt text is input into the language model, and the language model outputs the plurality of first response texts for the first prompt text; the reference response text for the first prompt text is determined from the plurality of first response texts; and the language model is trained based on the reference response text for the first prompt text. Thus, the first large model may be determined as the teacher model of the language model to perform the distillation learning on the language model, i.e., the knowledge of the first large model may be migrated to the language model. The language model has the advantages of small size, high accuracy and fast inference speed. In addition, the reference response text for the first prompt text may be determined from the plurality of first response texts to train the language model. The automatic obtaining of the reference response text of the language model and the self-evolution of the language model may be realized, and the labeling does not need to rely on the large model and manual labeling, which saves the labeling time of the training samples of the language model, improves the training efficiency of the language model, and is especially suitable for the training scenario in which multiple rounds of iterations have been performed on the language model. In addition, the first prompt text and the reference response text for the first prompt text may be obtained in the real service scenario of the language model, which makes the training samples of the language model closer to the real service scenario, improves the authenticity and diversity of the training samples of the language model, and improves the generalization and applicability of the language model in the real service scenario.

According to an embodiment of the disclosure, a question answering apparatus is also provided for implementing the question answering method.

FIG. 9 is a block diagram illustrating a question answering apparatus according to an embodiment of the disclosure.

As shown in FIG. 9, the question answering apparatus 900 includes a first obtaining module 901, a second obtaining module 902, and a processing module 903.

The first obtaining module 901 is configured to obtain a question text;

The second obtaining module 902 is configured to obtain a target prompt text based on the question text; and

The processing module 903 is configured to input the target prompt text into a question answering model, and output an answer text for the question text by the question answering model, in which the question answering model is obtained through the method for model training based on a large model according to the disclosure.

With the question answering apparatus provided in the disclosure, the question text is obtained, the target prompt text is obtained based on the question text, and the target prompt text is input into the question answering model, and the answer text for the question text is output by the question answering model, in which the question answering model is obtained through the method for model training based on a large model according to the disclosure. The question answering model has the advantages of small size, high accuracy and fast inference speed, which improves the efficiency of generating the answer text, i.e., improves the question answering efficiency, and thus improves the user experience in the question answering scenario. In addition, the question answering model has good generalization and applicability, which improves the accuracy of the answer text and is applicable to a plurality of question answering scenarios.

According to embodiments of the disclosure, it also provides an electronic device, a readable storage medium, and a computer program product.

Referring to FIG. 10, it is a block diagram illustrating an electronic device 1000 according to an embodiment of the disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relations, and their functions are merely examples, which are not intended to limit the implementations of the disclosure described and/or required herein.

As shown in FIG. 10, the device 1000 includes a computing unit 1001, configured to execute various appropriate actions and processes according to a computer program stored in a read-only memory (ROM) 1002 or a computer program loaded from a storage unit 1008 to a random access memory (RAM) 1003. In the RAM 1003, various programs and data required for the device 1000 may be stored. The computing unit 1001, the ROM 1002 and the RAM 1003 may be connected with each other by a bus 1004. An input/output (I/O) interface 10010 is also connected to the bus 1004.

The plurality of components in the device 1000 are connected to the I/O interface 1005, which include: an input unit 1006, for example, a keyboard, a mouse; an output unit 1007, for example, various types of displays, speakers; a storage unit 1008, for example, a magnetic disk, an optical disk; and a communication unit 1009, for example, a network card, a modem, a wireless transceiver. The communication unit 1009 allows the device 1000 to exchange information/data through a computer network such as Internet and/or various types of telecommunication networks with other devices.

The computing unit 1001 may be various types of general and/or dedicated processing components with processing and computing abilities. Some examples of a computing unit 1001 include but not limited to a central processing unit (CPU), a graphics processing unit (GPU), various dedicated artificial intelligence (AI) computing chips, various computing units on which a machine learning model algorithm is running, a digital signal processor (DSP), and any appropriate processor, controller, microcontroller, etc. The computing unit 1001 executes various methods and processes as described above, for example, a method for model training based on a large model and the question answering method. For example, in some embodiments, the method for model training based on a large model and the question answering method may be further implemented as a computer software program, which is tangibly contained in a machine readable medium, such as the storage unit 1008. In some embodiments, a part or all of the computer program may be loaded and/or installed on the device 1000 via the ROM 1002 and/or the communication unit 1009. When the computer program is loaded on the RAM 1003 and executed by the computing unit 1001, one or more steps in the method for model training based on a large model and the question answering method may be performed. Optionally, in other embodiments, the computing unit 1001 may be configured perform to the method for model training based on a large model and the question answering method in other appropriate ways (for example, by virtue of a firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program codes configured to implement the methods of the disclosure may be written in any combination of one or more programming languages. These program codes may be provided for the processors or controllers of general-purpose computers, dedicated computers, or other programmable data processing devices, so that the program codes, when executed by the processors or controllers, enable the functions/operations specified in the flowchart and/or block diagram to be implemented. The program codes may be executed entirely on the machine, partly executed on the machine, partly executed on the machine and partly executed on the remote machine as separate software packages, or entirely executed on the remote machine or server.

In the context of the disclosure, a machine-readable medium may be a tangible medium that may contain or store a program for used by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMS, ROMs, Electrically Programmable Read-Only-Memory (EPROM), fiber optics, Compact Disc Read-Only Memories (CD-ROM), optical storage devices, magnetic storage devices, or any suitable combination of the foregoing.

In order to provide interaction with a user account, the systems and techniques described herein may be implemented on a computer having a display device (e.g., a Cathode Ray Tube (CRT) or a Liquid Crystal Display (LCD) monitor) for displaying information to the user account; and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, front-end components, or any combination thereof. The components of the system may be interconnected by any form or medium of digital data communication (e.g., a communication network). Examples of communication networks include: a Local Area Network (LAN), a Wide Area Network (WAN), and the Internet.

The computer system may include a client and a server. The client and server are generally remote from each other and interact with each other through a communication network. The client-server relation is generated by operating computer programs on the respective computers and having a client-server relation with each other. The server may be a cloud server, a server of a distributed system, or a server combined with a block-chain.

According to embodiments of the disclosure, it also provides a computer program product. The computer program product includes a computer program. When the computer program is executed by a processor, the steps of the method for model training based on a large model or the question answering method according to the embodiments of the disclosure are performed.

It should be understood that the various forms of processes shown above can be used to reorder, add or delete steps. For example, the steps described in the disclosure may be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for model training based on a large model, comprising:
determining a first large model as a teacher model of a language model, and performing distillation learning on the language model based on the first large model;
inputting a first prompt text into the language model, and obtaining a plurality of first response texts for the first prompt text output by the language model;
determining a reference response text for the first prompt text from the plurality of first response texts; and
training the language model based on the reference response text for the first prompt text.

2. The method according to claim 1, wherein determining the reference response text for the first prompt text from the plurality of first response texts comprises:
obtaining scores of the plurality of first response texts; and
determining the reference response text for the first prompt text from the plurality of first response texts based on the scores.

3. The method according to claim 2, wherein obtaining the scores of the plurality of first response texts comprises:
inputting the first prompt text and each first response text into a reward model, and obtaining a reward for each first response text output by the reward model; and
determining the reward for each first response text as the score of a corresponding first response text.

4. The method according to claim 2, wherein obtaining the scores of the plurality of first response texts comprises:
inputting the first prompt text and each the first response text into a second large model, and obtaining scores of the plurality of first response texts output by the second large model.

5. The method according to claim 4, further comprising:
obtaining, based on the first prompt text, a second response text for the first prompt text via the second large model; and
obtaining, based on the plurality of first response texts and the second response text, the scores of the plurality of first response texts via the second large model.

6. The method according to claim 1, wherein training the language model based on the reference response text for the first prompt text comprises:
obtaining a first training sample of the language model by associating the first prompt text and the reference response text for the first prompt text; and
training the language model based on the first training sample.

7. The method according to claim 1, wherein training the language model based on the reference response text for the first prompt text comprises:
determining a first response text other than the reference response text in the plurality of first prompt texts as a third response text; and
training the language model based on the third response text and the reference response text for the first prompt text.

8. The method according to claim 1, wherein performing the distillation learning on the language model based on the first large model comprises:
inputting a second prompt text into the first large model, and obtaining a reference response text for the second prompt text output by the first large model;
obtaining a second training sample of the language model by associating the second prompt text and the reference response text for the second prompt text; and
training the language model based on the second training sample.

9. The method for questioning and answering according to claim 3, further comprising:
obtaining a sample prompt text, and a positive response text and a negative response text for the sample prompt text;
inputting the sample prompt text, the positive response text, and the negative response text into the reward model;
obtaining, based on the sample prompt text and the positive response text, a predicted reward for the positive response text via the reward model;
obtaining, based on the sample prompt text and the negative response text, a predicted reward for the negative response text via the reward model; and
training the reward model based on the predicted reward for the positive response text and the predicted reward for the negative response text.

10. The method according to claim 9, wherein training the reward model based on the predicted reward for the positive response text and the predicted reward for the negative response text comprises:
obtaining a loss function of the reward model based on a difference parameter between the predicted reward for the positive response text and the predicted reward for the negative response text; and
training the reward model based on the loss function of the reward model.

11. The method according to claim 9, further comprising:
obtaining a plurality of sample response texts for the sample prompt text; and
labeling, based on feedback data from a user group for the plurality of sample response texts, each of the plurality of sample response texts as the positive response text or the negative response text.

12. A question answering method, comprising:
obtaining a question text;
obtaining a target prompt text based on the question text; and
inputting the target prompt text into a question answering model, and outputting an answer text for the question text by the question answering model, wherein the question answering model is obtained through a method for model training based on a large model, the method comprising:
determining a first large model as a teacher model of a language model, and performing distillation learning on the language model based on the first large model;
inputting a first prompt text into the language model and outputting, by the language model, a plurality of first response texts for the first prompt text;
determining a reference response text for the first prompt text from the plurality of first response texts; and
training the language model based on the reference response text for the first prompt text.

13. The method according to claim 12, wherein determining the reference response text for the first prompt text from the plurality of first response texts comprises:
obtaining scores of the plurality of first response texts; and
determining the reference response text for the first prompt text from the plurality of first response texts based on the scores.

14. The method according to claim 13, wherein obtaining the scores of the plurality of first response texts comprises:
inputting the first prompt text and each first response text into a reward model, and obtaining a reward for each first response text output by the reward model; and
determining the reward for each first response text as the score of a corresponding first response text.

15. The method according to claim 13, wherein obtaining the scores of the plurality of first response texts comprises:
inputting the first prompt text and each the first response text into a second large model, and obtaining scores of the plurality of first response texts output by the second large model.

16. The method according to claim 15, further comprising:
obtaining, based on the first prompt text, a second response text for the first prompt text via the second large model; and
obtaining, based on the plurality of first response texts and the second response text, the scores of the plurality of first response texts via the second large model.

17. The method according to claim 12, wherein training the language model based on the reference response text for the first prompt text comprises:
obtaining a first training sample of the language model by associating the first prompt text and the reference response text for the first prompt text; and
training the language model based on the first training sample.

18. The method according to claim 12, wherein training the language model based on the reference response text for the first prompt text comprises:
determining a first response text other than the reference response text in the plurality of first prompt texts as a third response text; and
training the language model based on the third response text and the reference response text for the first prompt text.

19. An electronic device, comprising:
at least one processor; and
a memory communicatively coupled to the at least one processor and storing instructions executable by the at least one processor;
wherein when the instructions are executed by the at least one processor, the at least one processor is configured to:
determine a first large model as a teacher model of a language model, and perform distillation learning on the language model based on the first large model;
input a first prompt text into the language model, and obtain a plurality of first response texts for the first prompt text output by the language model;
determine a reference response text for the first prompt text from the plurality of first response texts; and
train the language model based on the reference response text for the first prompt text.

20. A non-transitory computer readable storage medium, storing computer instructions, wherein the computer instructions are configured to cause a computer to perform the method according to claim 1.
